(19) United States
(12) Patent Application Publication
(10) Pub. No.: US 2026/0115985 A1
(43) Pub. Date: Apr. 30, 2026

(54) Method for Predicting Multiple Qualities of Finished Products Using Feature Encoding with Machine Learning and Production Equipment

(71) Applicant: National Taiwan Normal University, Taipei City (TW)

(72) Inventors: Kun-Cheng Ke, Taipei City (TW); Jui-Chih Wang, Taipei City (TW)

(21) Appl. No.: 18/970,183

(22) Filed: Dec. 5, 2024

(30) Foreign Application Priority Data
Oct. 28, 2024 (TW) 113141106

(51) Int. Cl. B29C 45/76; B29C 45/77

(52) U.S. Cl. CPC B29C 45/768; B29C 45/77; B29C 2945/76006; B29C 2945/76257; B29C 2945/76949

(57) ABSTRACT

The present invention provides a method for predicting multiple qualities of finished products using feature encoding with machine learning, applicable for monitoring the manufacturing process in a production equipment. The method includes an experimental step, a data preprocessing step, a feature learning step, and a model calibration step. In experimental step, the production equipment produces a finished product under at least one process condition and obtains a detection data stream. In data preprocessing step, an autoencoder encodes the detection data stream to obtain a feature data stream, from which a quality index can be calculated. In feature learning step, a prediction module learns from the feature data stream and the quality index. In model calibration step, the prediction module is trained to learn the quality of the finished product to enhance the accuracy of the predictions made by the prediction module.

### TECHNICAL FIELD

This application relates to a method for predicting the quality of finished products in injection molding, and in particular to, a method for predicting multiple qualities of finished products using feature encoding with machine learning.

### BACKGROUND

Injection molding is a manufacturing process utilized for producing plastic products, where quality control primarily relies on setting and adjusting process parameters. Historically, monitoring methods focused on controlling the quality of injection-molded products by regulating pressure and temperature, employing cavity pressure integral as an indicator of molding quality. With advancements in technology, the injection molding industry has increasingly adopted intelligent manufacturing practices, leveraging computer systems to optimize parameter adjustments.

Machine learning, a branch of artificial intelligence, is dedicated to designing and analyzing algorithms that enable computers to learn autonomously. In the context of injection molding, the process encompasses multiple stages, each characterized by distinct settings, while detectors positioned at various locations capture different pressure data. As a result, real-time monitoring through machine learning presents significant challenges, and quality assessments are typically conducted only after the product is fully manufactured, complicating prompt responses to identified issues.

Additionally, the quality of injection molding is influenced by a multitude of factors, and the interplay among these variables can lead to diverse outcomes. Attempting to explain the nonlinear nature of the injection process using a limited set of variables or equations proves not only complex but also exceedingly difficult. For example, pressure sensors installed in an injection molding machine detect varying cavity pressures depending on their positions on the mold and the temperature of the molten material. Additionally, the injection molding pressure settings differ across various stages. Not only is it challenging for an average person to assess the injection quality based on the detected pressure variations, but it is also impossible to explain these variations through a limited set of variables or equations.

Therefore, it is essential for those skilled in the relevant field to develop effective methods for predicting the quality of injection-molded products and to achieve more accurate, real-time monitoring of the injection molding process, which has emerged as a critical area of focus within polymer processing.

### SUMMARY

One or more embodiments disclosed herein describe a method for predicting multiple qualities of finished products using feature encoding with machine learning, applicable for monitoring the manufacturing process in a production equipment, comprises an experimental step, a data preprocessing step, a feature learning step, a prediction step, and a model calibration step.

In experimental step, at least one process condition is set on the production equipment to manufacture a finished product, and a detection module is installed on the production equipment to obtain a detection data stream related to the finished product, which contains at least one quality indicator of the finished product.

In data preprocessing step, an autoencoder encodes the detection data stream to obtain a feature data stream, and the detection data stream is derived from data obtained through monitoring the manufacturing process.

In feature learning step, a prediction module that includes a multilayer perceptron learns from the feature data stream to enable the prediction module to predict the quality of the finished product.

In prediction step, the trained prediction module is incorporated into the production equipment to analyze the detection data stream obtained by the detection module, and generates quality prediction for the finished product produced by the production equipment, enabling monitoring of the actual production status of the production equipment.

In model calibration step, the prediction module is trained on the quality of the finished product to enhance the accuracy of the predictions made by the prediction module.

In some embodiments, in experimental step, the production equipment includes an injection molding machine, a mold connected to the injection molding machine, a mold cavity defined by the mold, and a runner defined by the mold, and the detection module is used to monitor the pressure in the mold cavity and the runner.

In some embodiments, in data preprocessing step, the detection data stream includes an injection pressure dataset, a holding pressure dataset, and a cooling pressure dataset, and the feature data stream obtained by the autoencoder includes an injection feature dataset, a holding feature dataset, and a cooling feature dataset.

In some embodiments, in data preprocessing step, the detection data stream includes a global pressure dataset, and the feature data stream obtained by the autoencoder includes a global feature dataset.

In some embodiments, in experimental step, the detection module includes a near-gate detector for detecting the pressure in the mold cavity, a center detector for detecting the pressure in the mold cavity, a far-gate detector for detecting the pressure in the mold cavity, and a system pressure detector for detecting the pressure in the runner.

In some embodiments, in experimental step, the quality indicators of the finished product include the finished product's dimensions and/or weight.

In some embodiments, in data preprocessing step, the detection data stream includes a detected peak index and a detected integral index, and a statistical model analyzes the correlation between the finished product quality, the feature data stream, the detected peak index, and the detected integral index to adjust the autoencoder, ensuring that the feature data stream obtained by the autoencoder has a high correlation with the detected peak index and the detected integral index.

In some embodiments, the method further comprising a validation step following the prediction step. In validation step, the prediction model undergoes validation for multiple qualities of the finished product.

Another one or more embodiments disclosed herein describe a production equipment suitable for the method of predicting multiple qualities of finished products using feature encoding with machine learning. The production equipment manufactures a finished product, and comprises an injection molding machine, a mold connected to the injection molding machine, a mold cavity defined by the mold, a runner defined by the mold, a detection module installed in the mold, and a prediction module connected to the detection module. The detection module is used for detecting the pressure in the mold cavity, and the prediction module is used for analyzing the detection data from the detection module and predicting the quality of the finished product.

The features of the present invention lie in the prediction module's approach of separately learning from the injection feature dataset, the holding feature dataset, and the cooling feature dataset. By learning the manufacturing characteristics of each stage of the production equipment, the prediction module, once trained, can monitor the production status of the equipment and thereby control the quality of each finished product to enhance the production efficiency of the equipment.

### BRIEF DESCRIPTION OF THE DRAWINGS

FIG. 1 is a flowchart illustrating a method for predicting multiple qualities of finished products using feature encoding with machine learning, in accordance with an embodiment of the invention;

FIG. 2 is a schematic diagram of the setup of a production equipment, in accordance with an embodiment of the invention;

FIG. 3 is a top view schematic diagram of a mold cavity and runner, in accordance with an embodiment of the invention;

FIG. 4 is a flowchart of the learning process of the prediction module, in accordance with an embodiment of the invention;

FIG. 5 is a structural schematic diagram of the finished product, in accordance with an embodiment of the invention;

FIG. 6 is a detection chart of the detection module, in accordance with an embodiment of the invention;

FIG. 7(a) is a schematic diagram of the encoding and decoding of the global pressure dataset, in accordance with an embodiment of the invention;

FIG. 7(b) is a schematic diagram of the encoding and decoding of the injection pressure dataset, in accordance with an embodiment of the invention;

FIG. 7(c) is a schematic diagram of the encoding and decoding of the holding pressure dataset, in accordance with an embodiment of the invention;

FIG. 7(d) is a schematic diagram of the encoding and decoding of the cooling pressure dataset, in accordance with an embodiment of the invention;

FIG. 8(a) is a comparison chart of width W1 between global prediction and index prediction, in accordance with an embodiment of the invention;

FIG. 8(b) is a comparison chart of width W2 between global prediction and index prediction, in accordance with an embodiment of the invention;

FIG. 8(c) is a comparison chart of width W3 between global prediction and index prediction, in accordance with an embodiment of the invention;

FIG. 8(d) is a comparison chart of length L1 between global prediction and index prediction, in accordance with an embodiment of the invention;

FIG. 8(e) is a comparison chart of length L2 between global prediction and index prediction, in accordance with an embodiment of the invention;

FIG. 8(f) is a comparison chart of length L3 between global prediction and index prediction, in accordance with an embodiment of the invention;

FIG. 8(g) is a comparison chart of the weight of the finished product between global prediction and index prediction, in accordance with an embodiment of the invention.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

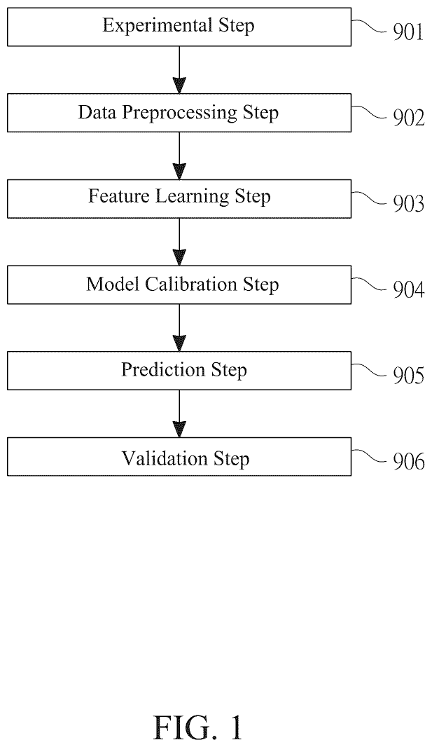

FIG. 1 illustrates a method for predicting multiple qualities of finished products using feature encoding with machine learning in accordance with an embodiment of the invention. The method comprises an experimental step 901, a data preprocessing step 902, a feature learning step 903, a model calibration step 904, a prediction step 905, and a validation step 906.

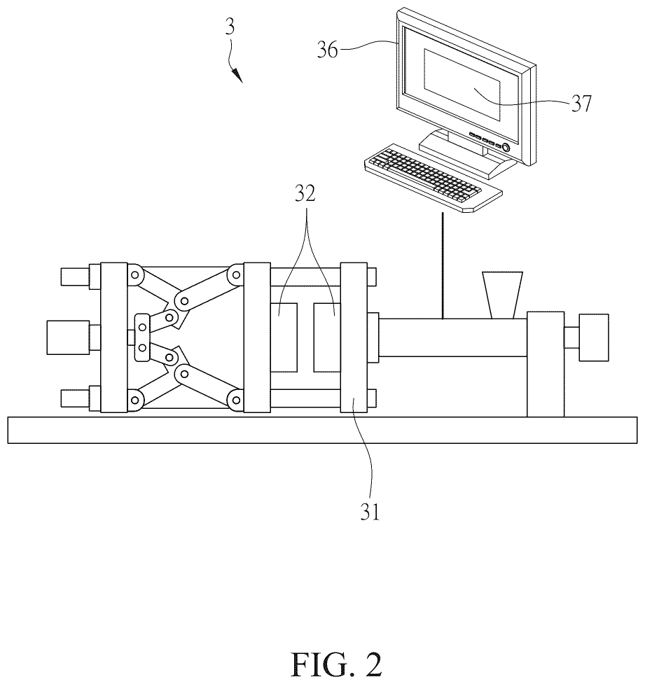

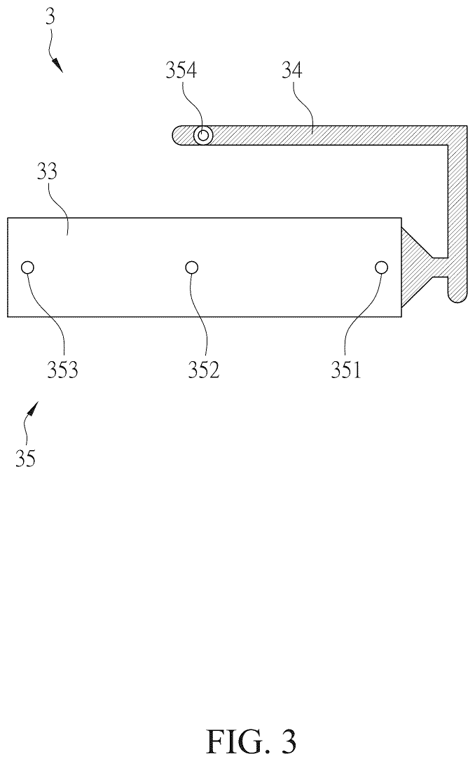

Referring to FIGS. 2 and 3, the method is applicable for monitoring the manufacturing process in a production equipment 3 during the mass production of a finished product 21. In an exemplary embodiment, the finished product 21 can be an injection-molded item. The production equipment 3 includes an injection molding machine 31, a mold 32, a mold cavity 33, a runner 34, a detection module 35, a computer 36, and a prediction module 37.

The mold 32 is connected to the injection molding machine 31, and the mold 32 encloses and defines the mold cavity 33 and runner 34. The detection module 35 is installed on the mold 32 and can measure the pressure in both the mold cavity 33 and runner 34. The computer 36 is connected to the detection module 35, controlling the injection pressure and melt temperature of the injection molding machine 31. The prediction module 37 is integrated into the computer 36 and connected to the detection module 35. Since the injection molding machine 31 is similar to existing ones, further details will not be reiterated here. In some embodiments, the detection module 35 can be a pressure sensor, temperature sensor, flow sensor, or displacement sensor, but it is not limited to these. In some embodiments, the prediction module 37 can be the computer 36 with a Graphics Processing Unit (GPU), an edge computing device, an embedded computing device, or a Programmable Logic Controller (PLC), but it is not limited to these. In an exemplary embodiment, the detection module 35 is a pressure sensor, and the prediction module 37 is implemented on the computer 36 equipped with a GPU. The computer 36 includes an AMD Ryzen 9 5900X processor, an Nvidia Geforce RTX 3070 graphics card, and 64 GB of RAM. The computer 36 utilizes Moldex3D 2023 software for polymer mold flow analysis, covering aspects such as flow-front time, temperature, molten pressure, center of clamping force, displacement, residual stress, and optical analysis. Additionally, MATLAB 2023b is used on the computer 36 for data preprocessing and the development and training of the artificial intelligence model, which serves as the prediction module 37 in this present invention. The production equipment 3 is configured as follows: the injection molding machine 31 used is the LA40 model from Sodick, Japan, with a maximum clamping force of 40 tons, and a V/P switching position set at 98% of the filling volume. Parameters adjusted through the Taguchi method include injection speed, holding pressure, holding time, melt temperature, and cooling time. The polymer material utilized is Polystyrene (GPPS PG-33, CHIMEI, Taiwan). However, this setup is not limited to the specified configurations in actual operations.

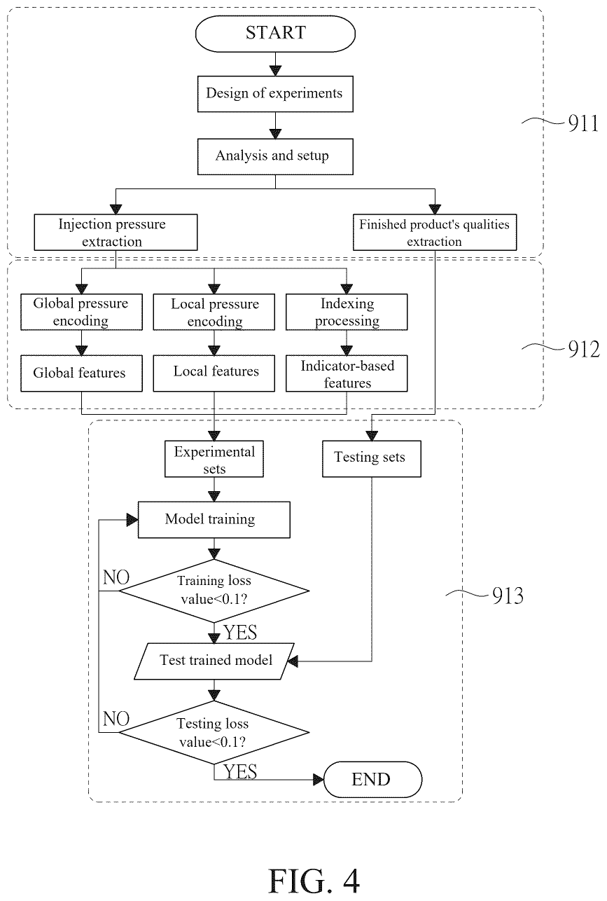

Turing to FIG. 4, a flowchart of the learning process is illustrated. In this learning process, process one 911 corresponds to the experimental step 901, process two 912 corresponds to the data preprocessing step 902, and process three 913 corresponds to the feature learning step 903 and the model calibration step 904.

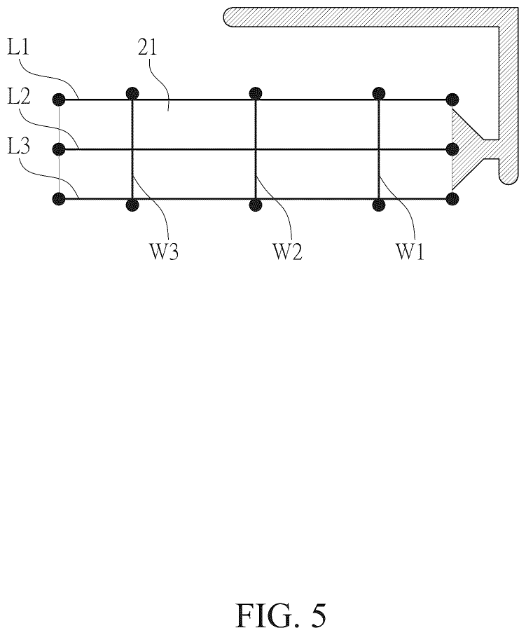

Referring also to FIG. 5, in experimental step 901, at least one process condition is set on the production equipment 3 to produce a finished product 21. The detection module 35 installed on the production equipment 3 can capture a detection data stream for the finished product 21, which includes at least one quality indicator of the finished product.

In process one 911, which corresponds to experimental step 901, the process begins with setting the specifications for each device within the production equipment 3 during the design of experiment. The production equipment 3 used in the method of the present invention is equipment designed for manufacturing plastic products. In an exemplary implement, the production equipment 3 used in this method can also be manufacturing equipment in other fields. In some embodiments, the injection molding machine 31 is a hybrid hydraulic-electric injection machine (LA40, Sodick, Japan), and the polymer material used is polystyrene.

In some embodiments, the structure of the finished product 21 comprises a rectangular main body (formed by the mold cavity 33) and an extended structure connected to one side of the rectangular main body (formed by the runner 34). The finished product 21 measures 120 mm in length, 30 mm in width, and 3 mm in thickness, though these dimensions are not limiting. The quality of product 21 is assessed based on its dimensions and weight, with specific measurement positions defined as length L1, L2, and L3, and width W1, W2, and W3. Length L1, L2, and L3 are positioned at the top, middle, and bottom of the finished product 21, respectively, while width W1, W2, and W3 are located on the right, center, and left sides of the finished product 21, respectively. The product's weight includes the combined weight of the mold cavity 33 and the runner 34. Other measurement methods may also be applied as appropriate to assess product quality and are not limited to those described here.

In some embodiments, machine simulation is used to simulate the production conditions of production equipment 3. The simulation utilizes Moldex3D software to analyze polymer mold flow, enabling the extraction of information needed for artificial intelligence modeling, such as flow-front time, temperature, molten pressure, displacement, and residual stress. Additionally, MATLAB is employed for data preprocessing and AI model training; however, other software and methods may also be applied as appropriate.

In the analysis and setup stage of process one 911 within experimental step 901, the production equipment 3 includes the injection molding machine 31, the mold 32 connected to the injection molding machine 31, the mold cavity 33 defined by the mold 32, and the runner 34 defined by the mold 32. The detection module 35 is configured to monitor the pressure within the mold cavity 33 and the runner 34. In some embodiments, the detection module 35 includes a near-gate detector 351, a center detector 352, a far-gate detector 353 for measuring pressure of the mold cavity 33, and a system pressure detector 354 for monitoring runner pressure. Other configurations may also be applied as appropriate.

In experimental step 901, two distinct methods are used for mold flow analysis. For example, the first method employs a general, widely-used approach, while the second method uses the Taguchi experimental design method. Both methods identify optimal process conditions. The optimal parameters identified by the first method are an injection speed of 20 mm/s, holding pressure of 60 MPa, holding time of 4.5 seconds, melt temperature of 185° C., and cooling time of 20 seconds. The second method determines the optimal parameters as an injection speed of 10 mm/s, holding pressure of 80 MPa, holding time of 7 seconds, melt temperature of 205° C., and cooling time of 25 seconds.

In some embodiments, the quality indicators for the finished product 21 include the product dimensions and/or product weight. During process one 911, injection pressure data is captured using four designated sensors. The product dimension standards include measurements at length L1, L2, L3, width W1, W2, W3, and the product weight. In some embodiments, machine simulation is used to directly obtain these data.

In data preprocessing step 902, an autoencoder 22 encodes the detection data stream to generate a feature data stream. The detection data stream comprises a global pressure dataset, an injection pressure dataset, a holding pressure dataset, a cooling pressure dataset, a detected peak index, and a detected integral index. The global pressure dataset contains all the data from the detection stream and can be segmented into the injection, holding, and cooling pressure datasets based on different injection molding stages.

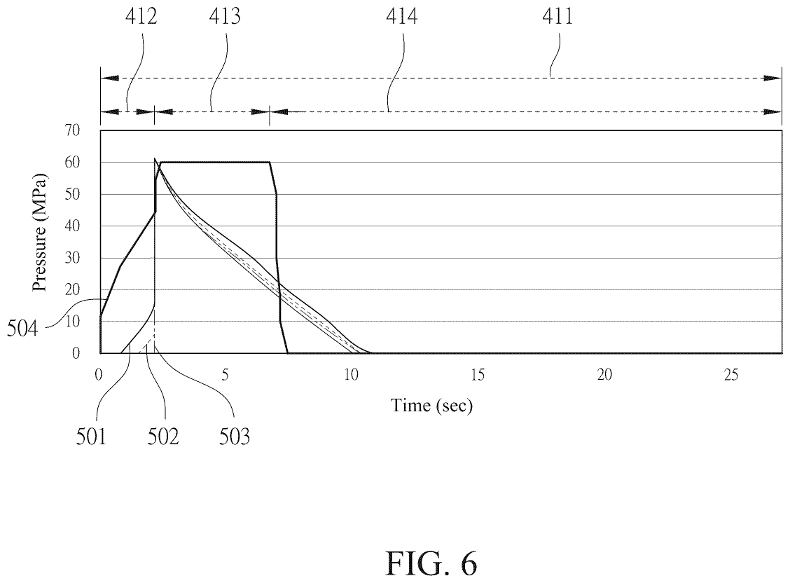

Referring to FIG. 6, which shows the data collected by detection module 35, the horizontal axis represents time (in seconds), and the vertical axis represents pressure (in MPa). Curve 501 corresponds to data from the near-gate detector 351, curve 502 to the center detector 352, curve 503 to the far-gate detector 353, and curve 504 to the system pressure detector 354. The pressure data recorded during the global stage 411, injection stage 412, holding stage 413, and cooling stage 414 are represented by the global, injection, holding, and cooling pressure datasets, respectively. In FIG. 6, curves 501, 502, 503, and 504 overlap after 10 seconds and extend to 27 seconds.

The autoencoder 22 encodes the global, injection, holding, and cooling pressure datasets, producing a feature data stream. This feature data stream contains a global feature dataset, an injection feature dataset, a holding feature dataset, and a cooling feature dataset.

Referring back to FIG. 4, the global pressure encoding in process two 912 includes the global pressure dataset. The local pressure encoding in process two 912 includes the injection, holding, and cooling pressure datasets. The global features in process two 912 encompass the global feature dataset, while the local features include the injection, holding, and cooling feature datasets. Additionally, the indexing processing in process two 912 involves calculating the peak value and integral of the detected data stream. The indicator-based features in process two 912 include the detected peak index and the detected integral index.

In some embodiments, the global, injection, holding, and cooling pressure datasets are first linearly interpolated to obtain 2,000 data points each. Then, the global, injection, holding, and cooling pressure datasets are provided to the autoencoder 22 for encoding.

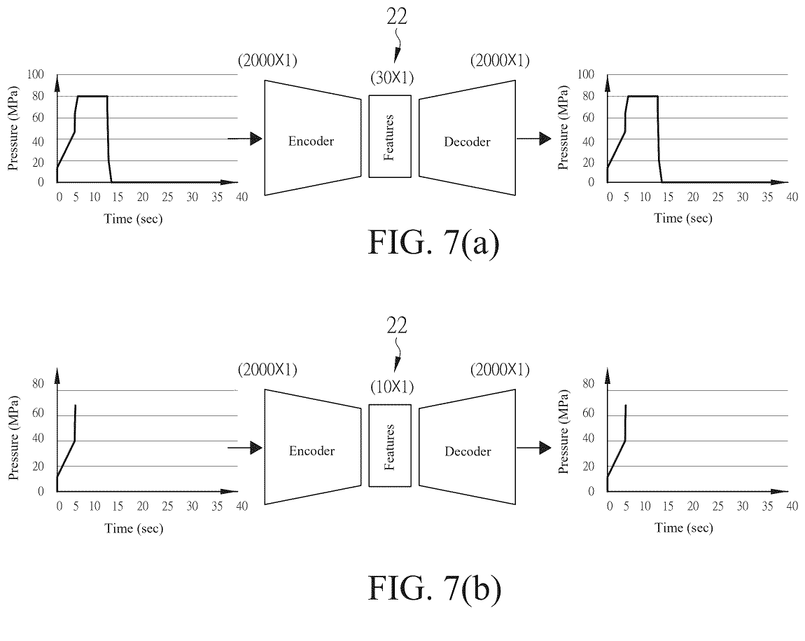

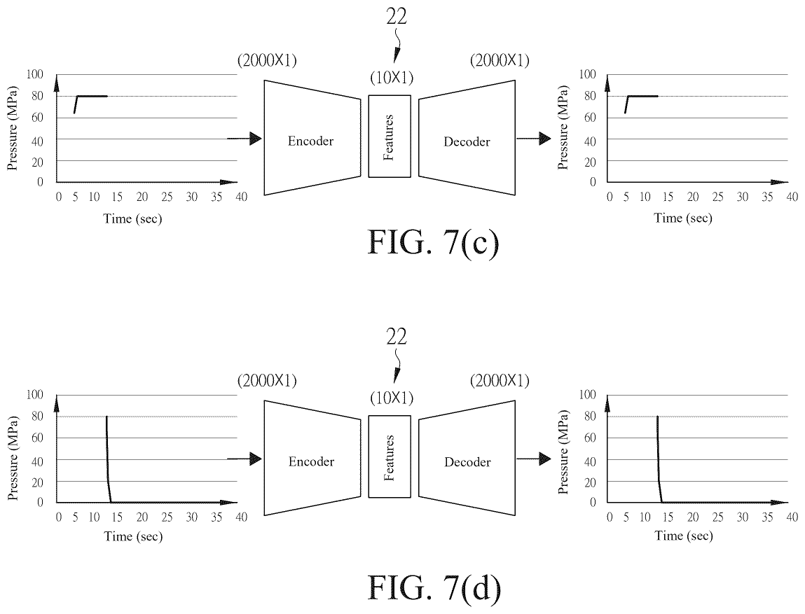

Turning to FIGS. 7(a)-7(d) for an example based on data from the system pressure detector 354. In FIG. 7(a), the global pressure dataset with 2,000 data points is encoded to yield a global feature dataset containing 30 feature points, which, upon decoding, returns 2,000 global decoded data points. In FIG. 7(b), the injection pressure dataset with 2,000 data points is encoded to produce an injection feature dataset with 10 feature points, then decoded back to 2,000 injection decoded data points. FIG. 7(c) shows the holding pressure dataset, also with 2,000 data points, encoded into a holding feature dataset with 10 feature points and decoded back to 2,000 holding decoded data points. In FIG. 7(d), the cooling pressure dataset undergoes the same process, yielding 10 cooling feature points and subsequently 2,000 decoded cooling data points. The data from the near-gate detector 351, the center detector 352, and the far-gate detector 353 are encoded and decoded similarly and are not separately detailed here. After decoding the feature data stream, the autoencoder 22 can proceed with verification.

The Root-Mean-Square Error (RMSE) is calculated to assess the discrepancy between the features generated by the autoencoder 22 and the original data, optimizing the input layers of the multilayer perceptron for better prediction accuracy.

For the global stage 411, the global pressure dataset encompasses all pressure variations from start to finish. By adjusting training and fine-tuning parameters, the minimum reconstruction error values achieved are as follows: 4.79 MPa for the near-gate detector 351, 4.92 MPa for the center detector 352, 4.85 MPa for the far-gate detector 353, and 4.99 MPa for the system pressure detector 354.

For the injection stage 412, the reconstruction loss values are as follows: 0.61 MPa for the near-gate detector 351, 0.17 MPa for the center detector 352, 0.03 MPa for the far-gate detector 353, and 0.84 MPa for the system pressure detector 354. All are controlled within 1 MPa, indicating excellent encoding performance by the autoencoder 22.

For the holding stage 413, the reconstruction loss values are as follows: 2.24 MPa for the near-gate detector 351, 2.59 MPa for the center detector 352, 2.38 MPa for the far-gate detector 353, and 1.09 MPa for the system pressure detector 354. The reconstruction loss values are slightly higher but still within an acceptable range.

For the cooling stage 414, the reconstruction loss values are as follows: 0.55 MPa for the near-gate detector 351, 0.79 MPa for the center detector 352, 0.85 MPa for the far-gate detector 353, and 0.68 MPa for the system pressure detector 354. All are controlled within 1 MPa, indicating excellent encoding performance by the autoencoder 22.

Continuing from the above, the autoencoder 22 demonstrates encoding capability, with relatively low error rates during the injection stage 412 and cooling stage 414. Although the error during the holding stage 413 is slightly higher, it is still an improvement compared to the error in the global stage 411, showing that the autoencoder 22 performs exceptionally well in local encoding.

The detected peak index represents the maximum value within the detection data stream, indicating the highest pressure from the injection stage 412 through the holding stage 413. This detected peak index acts as the driving force pushing the melt forward into the mold cavity 33, affecting the mass of the melt within the mold cavity 33 and determining the geometric quality (product dimensions) of the finished product 21.

The detected integral index is the integral of the detection data stream, representing the area under the pressure curve for the entire injection molding process (including the injection stage 412, holding stage 413, and cooling stage 414). The detected integral index reflects the quality of the finished product 21, directly influencing its final weight.

In data preprocessing step 902, a statistical model is also used to analyze the correlation among product quality, the feature data stream, the detected peak index, and the detected integral index to help in adjusting the autoencoder 22.

Within data preprocessing step 902, analysis methods utilizing the global feature dataset, injection feature dataset, holding feature dataset, detected peak index, and detected integral index are employed to assess the relationship between the product dimensions (including measurements length L1, L2, L3, and width W1, W2, W3) and the product's total weight.

In some embodiments, the statistical model uses the Pearson correlation coefficient (PCC) to explore the relationship between the feature data stream and the detected peak index and/or the detected integral index. The correlation value calculated by the model ranges from 0 to 1, with values closer to 1 indicating a stronger relationship and values closer to 0 indicating a weaker relationship. Specifically, a correlation of 0 indicates no relationship; 0 to 0.25 is negligible, 0.25 to 0.5 is poor, 0.5 to 0.75 is moderate, and 0.75 to 1 is strong, with 1 being perfect.

For the 30 global feature datasets derived from the near-gate detector 351, center detector 352, far-gate detector 353, and system pressure detector 354, 90% have a correlation coefficient between 0 and 0.5 with product quality, indicating a weak relationship. In other words, the global pressure datasets detected by the near-gate detector 351, center detector 352, far-gate detector 353, and system pressure detector 354 during the global stage 411 do not accurately reflect the product quality in terms of width, length, and weight for the finished product 21 produced by the production equipment 3.

For the 10 injection feature datasets detected by the near-gate detector 351, center detector 352, far-gate detector 353, and system pressure detector 354, 90% exhibit a correlation coefficient between 0 and 0.25 with product quality, which is considered negligible. This indicates that, during the injection stage 412, the injection pressure datasets detected by the near-gate detector 351, center detector 352, far-gate detector 353, and system pressure detector 354 do not effectively reflect the width, length, and weight quality for the finished product 21 produced by the production equipment 3.

For the 10 holding feature datasets detected by the near-gate detector 351, center detector 352, far-gate detector 353, and system pressure detector 354, the correlation coefficient with product quality falls between 0.5 and 0.6, indicating a moderate correlation. This highlights the critical role of the holding stage 413 in the injection molding process, especially in ensuring the final product's dimensions and weight. Applying holding pressure during this stage ensures that the plastic fully fills the mold 32 and maintains shape stability, preventing width inconsistencies and surface defects. Additionally, adjusting the pressure can control the density and flow properties of the plastic, impacting product weight quality. Therefore, during the holding stage 413, the pressure datasets detected by the near-gate detector 351, center detector 352, far-gate detector 353, and system pressure detector 354 effectively reflect the width, length, and weight of the finished product 21 produced by the production equipment 3.

For the 10 cooling feature datasets detected by the near-gate detector 351, center detector 352, far-gate detector 353, and system pressure detector 354, the correlation coefficient with product quality is between 0.4 and 0.5, indicating a moderate correlation. This demonstrates that the cooling stage 414 has a critical impact on the final product's dimensional stability and consistency. The cooling rate of the plastic within the mold 32 directly affects the dimensional stability and quality consistency of the final product 21. If the cooling rate is too rapid, it may cause uneven plastic shrinkage, thereby affecting dimensional stability, while insufficient cooling time could lead to incomplete internal solidification, potentially causing deformation or shrinkage issues during subsequent use. Thus, an appropriate cooling rate ensures that the plastic solidifies fully, maintaining the product's shape and structural integrity, thereby affecting the product's dimensional and weight quality. In other words, the cooling pressure datasets detected by the near-gate detector 351, center detector 352, far-gate detector 353, and system pressure detector 354 during the cooling stage 414 effectively reflect the width, length, and weight of the finished product 21 produced by the production equipment 3.

Based on the above analysis, appropriately controlling the injection pressure during the holding stage 413 and the cooling stage 414 can effectively influence the quality of the finished product 21.

Referring to Table 1 below, which illustrates the correlation coefficients between the detected peak index and detected integral index with product quality. Higher correlation coefficients indicate a stronger relationship between the compared data, while lower values indicate weaker correlations. In Table 1, SN1 refers to the near-gate detector 351, SN2 to the center detector 352, SN3 to the far-gate detector 353, and SN4 to the system pressure detector 354. Product quality indicators include width (W1, W2, W3), length (L1, L2, L3), and product weight (W). The peak index represents the detected peak value, and the integral index represents the detected integral value in Table 1.

TABLE 1

| | SN1 | | SN2 | | SN3 | | SN4 | |
|---|---|---|---|---|---|---|---|---|
| | Peak | Integral | Peak | Integral | Peak | Integral | Peak | Integral |
| | Index | Index | Index | Index | Index | Index | Index | Index |
| W1 | 0.76 | 0.84 | 0.78 | 0.82 | 0.79 | 0.81 | 0.60 | 0.87 |
| W2 | 0.58 | 0.73 | 0.60 | 0.73 | 0.61 | 0.72 | 0.44 | 0.72 |
| W3 | 0.51 | 0.69 | 0.54 | 0.69 | 0.56 | 0.69 | 0.38 | 0.68 |
| L1 | 0.81 | 0.93 | 0.83 | 0.93 | 0.85 | 0.92 | 0.65 | 0.91 |
| L2 | 0.77 | 0.92 | 0.80 | 0.91 | 0.81 | 0.91 | 0.62 | 0.89 |
| L3 | 0.81 | 0.93 | 0.84 | 0.93 | 0.85 | 0.92 | 0.66 | 0.91 |
| W | 0.91 | 0.75 | 0.91 | 0.72 | 0.91 | 0.70 | 0.83 | 0.83 |

From Table 1, it is evident that the correlation coefficients between the detected peak index and integral index with the quality of the finished product 21 range from moderate to strong, with a maximum value of 0.93. This indicates that both the detected peak index and integral index effectively reflect variations in product quality.

In feature learning step 903, the prediction module 37 includes a multilayer perceptron (MLP). The prediction module 37 learns from the feature data stream, the detected peak index, and the detected integral index to gain the capability of predicting the quality of the finished product 21. The calculated correlation from the feature data stream serves as input to the input layers of the multilayer perceptron in the prediction module 37.

Referring to FIG. 4, in process three 913 of the feature learning step 903, the dataset was divided into experimental sets (80%) and testing sets (20%). The global feature dataset, injection feature dataset, holding feature dataset, cooling feature dataset, detected peak index, and detected integral index serve as the experimental sets (80%) for the multilayer perceptron in the prediction module 37. In some embodiments, the experimental sets (80%) contain 43 pressure data points used to train the model data in the multilayer perceptron.

The model training in the multilayer perceptron can compare the artificial intelligence prediction results with actual observations to assess the training loss. If the training loss value exceeds 0.1, the prediction module 37 undergoes additional training to reduce prediction discrepancies. Once the training loss value is below 0.1, it proceeds to the model calibration step 904.

Turning to Table 2 for details on the parameter structure of the multilayer perceptron in the prediction module 37 in some embodiments.

TABLE 2

| Item | Parameter |
|---|---|
| Software | Matlab 2023a |
| Loss function | RMSE |
| Input layers | Global feature dataset (120) |
| | Injection feature datasets (40) |
| | Holding feature datasets (40) |
| | Cooling feature datasets (40) |
| | Detected peak index (4) |
| | Detected integral index (4) |
| Output layers | L1, L2, L3, W1, W2, W3, and weight (7) |
| Hidden layers | 5 |
| Hidden layer node | [4, 6, 8, 6, 4] |
| Optimizer | Levenberg-Marquardt backpropagation |
| Experimental dataset | 43 |
| Testing dataset | 11 |

In model calibration step 904, the prediction module 37 further learns from the product quality data to improve its prediction accuracy.

Referring back to FIG. 4, in process three 913 of the model calibration step 904, the product quality dimensions (including length L1, L2, L3 and width W1, W2, W3) and product weight (total weight) serve as the testing sets (20%) for the multilayer perceptron in the prediction module 37. In some embodiments, the testing sets (20%) consist of 11 samples. The test trained model in the multilayer perceptron is using the testing sets (20%) to evaluate the learning results. If the testing loss value of the model data exceeds 0.1, the feature learning step 903 is re-executed. When the testing loss value of the model data is less than 0.1, the learning process concludes, and the prediction module 37 gains the capability to predict multiple quality attributes of the finished product 21 produced by production equipment 3.

In prediction step 905, the prediction module 37 is integrated into production equipment 3 to predict the actual production status of the equipment.

The prediction module 37, having undergone training through the method for predicting multiple qualities of finished products using feature encoding with machine learning, can analyze the detection data from the detection module 35 and predict the quality of the finished product 21. When the production equipment 3 is mass-producing multiple finished products 21, it can monitor each product individually, achieving the effect of filtering out defective finished products 21.

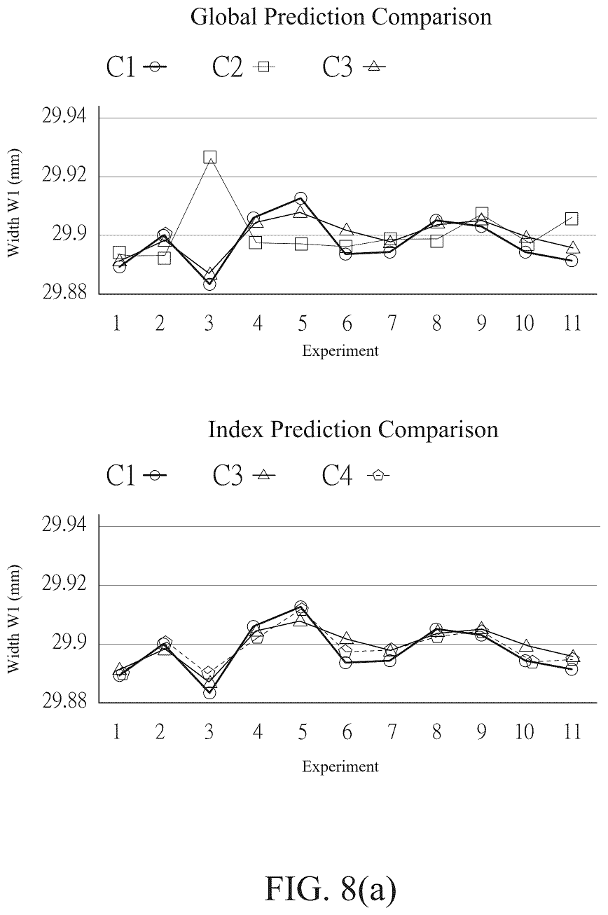

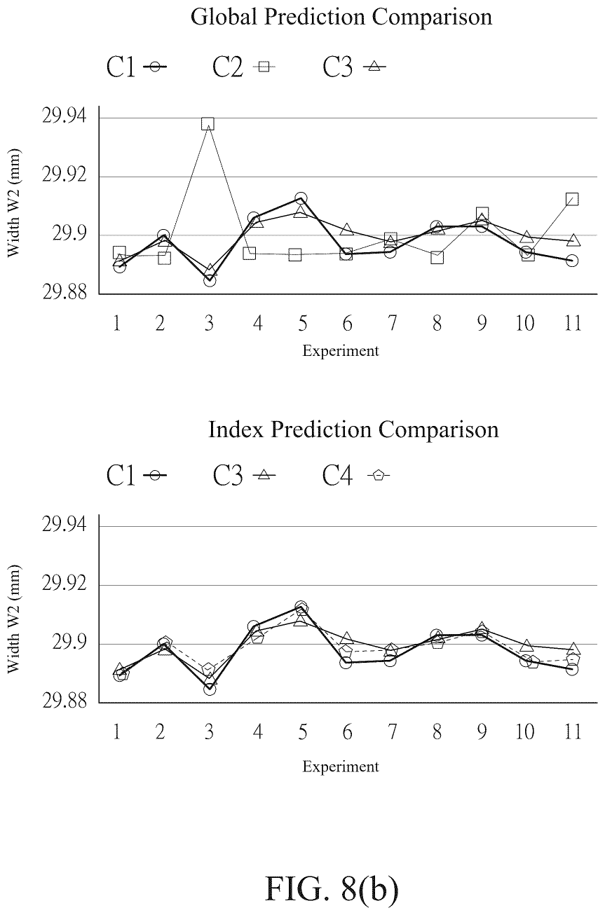

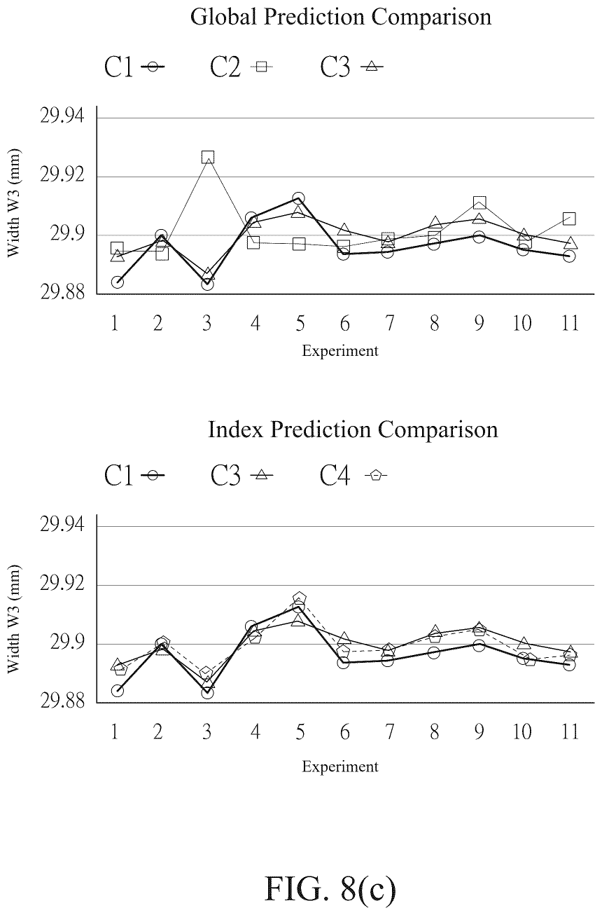

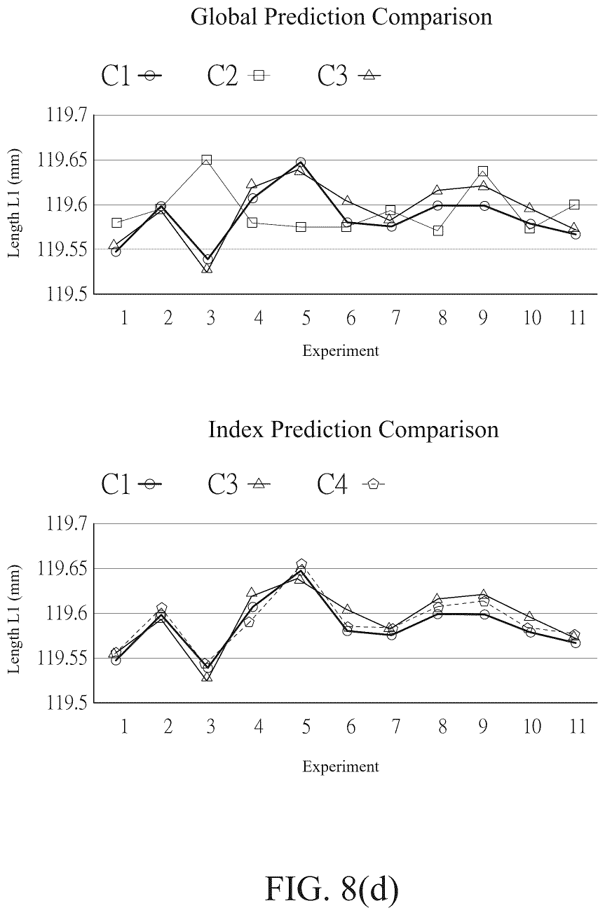

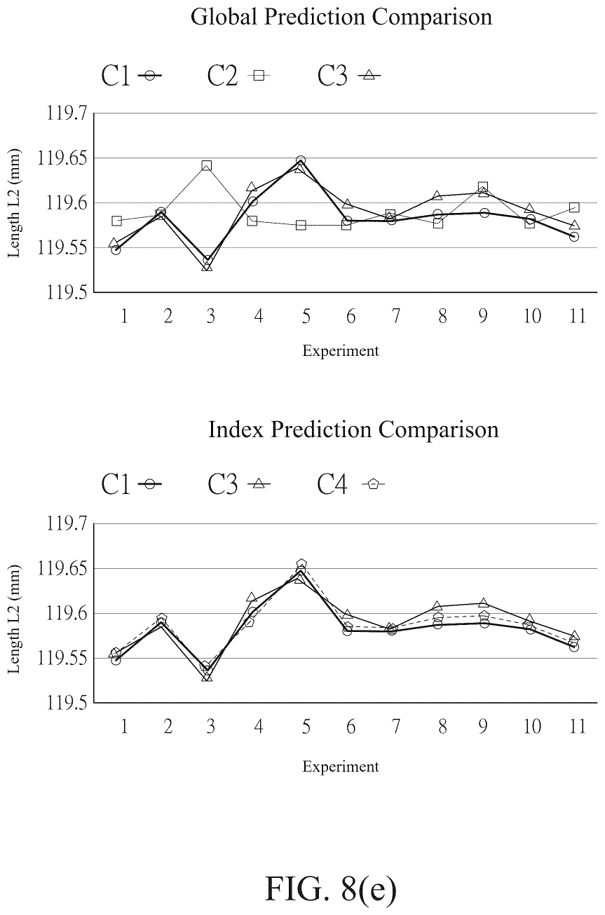

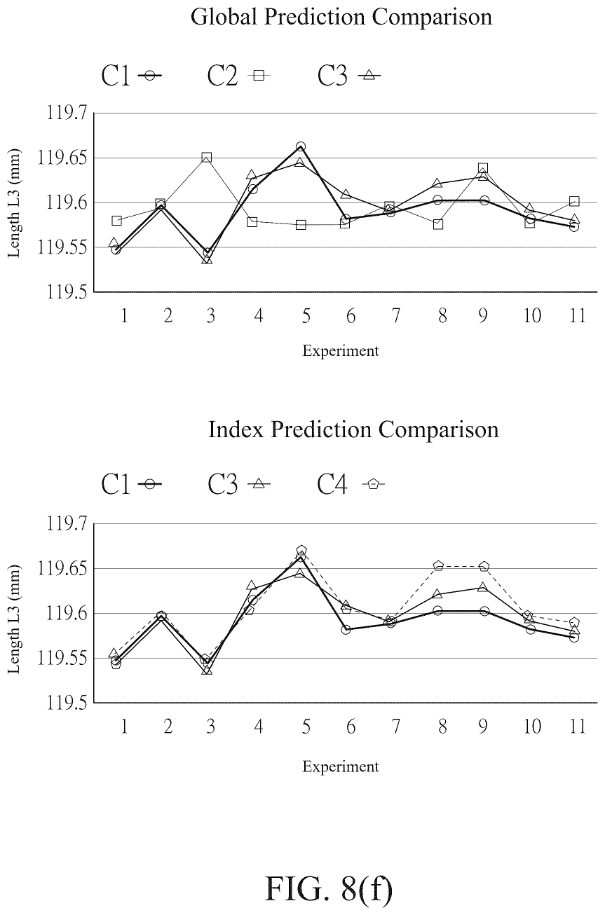

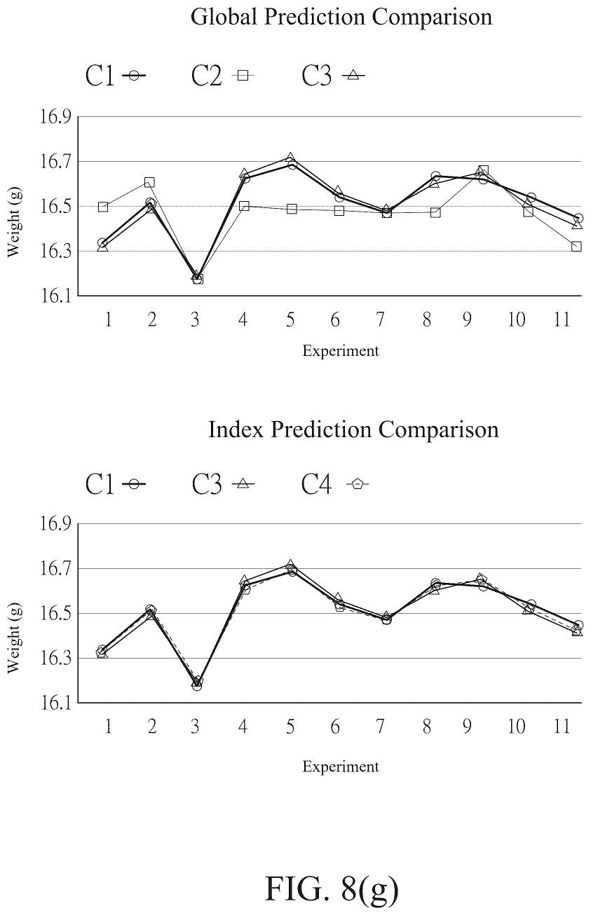

FIGS. 8(a) to 8(g) present comparison charts among simulated data C1 (line with circular nodes), global prediction C2 (line with square nodes), local prediction C3 (line with triangle nodes), and index prediction C4 (line with pentagon nodes). The simulated data C1 consists of 11 sample from the testing sets simulating product quality. The global prediction C2 represents the quality predictions made by prediction module 37 using the global pressure dataset, the local prediction C3 represents quality predictions based on injection, holding, and cooling pressure datasets, and the index prediction C4 represents quality predictions using the detected peak index and detected integral index.

In FIGS. 8(a) to 8(g), the horizontal axis values 1 to 11 represent the 11 samples in the testing sets for simulated data C1, global prediction C2, local prediction C3, and index prediction C4, corresponding to product quality measurements.

The upper chart in FIG. 8(a) shows a global prediction comparison, displaying data for width W1 from simulated data C1, global prediction C2, and local prediction C3, with the vertical axis representing width W1 (in mm) and the horizontal axis unscaled. The lower chart in FIG. 8(a) presents an index prediction comparison, displaying data for width W1 from simulated data C1, index prediction C4, and local prediction C3, with the vertical axis representing width W1 (in mm) and the horizontal axis unscaled.

The upper chart in FIG. 8(b) shows a global prediction comparison, displaying width W2 data from simulated data C1, global prediction C2, and local prediction C3, with the vertical axis representing width W2 (in mm) and the horizontal axis unscaled. The lower chart in FIG. 8(b) presents an index prediction comparison, displaying width W2 data from simulated data C1, index prediction C4, and local prediction C3, with the vertical axis representing width W2 (in mm) and the horizontal axis unscaled.

The upper chart in FIG. 8(c) shows a global prediction comparison, displaying data for width W3 from simulated data C1, global prediction C2, and local prediction C3, with the vertical axis representing width W3 (in mm) and the horizontal axis unscaled. The lower chart in FIG. 8(c) presents an index prediction comparison, displaying data for width W3 from simulated data C1, index prediction C4, and local prediction C3, with the vertical axis representing width W3 (in mm) and the horizontal axis unscaled.

The upper chart in FIG. 8(d) shows a global prediction comparison, displaying data for length L1 from simulated data C1, global prediction C2, and local prediction C3, with the vertical axis representing length L1 (in mm) and the horizontal axis unscaled. The lower chart in FIG. 8(d) presents an index prediction comparison, displaying data for length L1 from simulated data C1, index prediction C4, and local prediction C3, with the vertical axis representing length L1 (in mm) and the horizontal axis unscaled.

The upper chart in FIG. 8(e) shows a global prediction comparison, displaying data for length L2 from simulated data C1, global prediction C2, and local prediction C3, with the vertical axis representing length L2 (in mm) and the horizontal axis unscaled. The lower chart in FIG. 8(e) presents an index prediction comparison, displaying data for length L2 from simulated data C1, index prediction C4, and local prediction C3, with the vertical axis representing length L2 (in mm) and the horizontal axis unscaled.

The upper chart in FIG. 8(f) shows a global prediction comparison, displaying data for length L3 from simulated data C1, global prediction C2, and local prediction C3, with the vertical axis representing length L3 (in mm) and the horizontal axis unscaled. The lower chart in FIG. 8(f) presents an index prediction comparison, displaying data for length L3 from simulated data C1, index prediction C4, and local prediction C3, with the vertical axis representing length L3 (in mm) and the horizontal axis unscaled.

The upper chart in FIG. 8(g) shows a global prediction comparison, displaying data for product weight from simulated data C1, global prediction C2, and local prediction C3, with the vertical axis representing weight (in grams) and the horizontal axis unscaled. The lower chart in FIG. 8(g) presents an index prediction comparison, displaying data for product weight from simulated data C1, index prediction C4, and local prediction C3, with the vertical axis representing weight (in grams) and the horizontal axis unscaled.

From FIGS. 8(a) to 8(g), it can be understood that global prediction C2 shows a larger prediction errors when compared to simulated data C1, while local prediction C3 and index prediction C4 show smaller prediction errors relative to simulated data C1. This implies that the prediction module 37, when trained with global pressure datasets, produces predictions with a higher deviation from actual product quality. In contrast, when the module 37 is trained using the injection, holding, and cooling pressure datasets, the resulting product quality predictions have lower error margins relative to actual product quality, demonstrating the model's ability to achieve accurate predictions without domain knowledge by simulating learning at each injection stage. Additionally, the predictions derived from training with detected peak and integral indices also exhibit reduced error margins, reflecting a level of prediction accuracy typically requiring domain knowledge in injection molding.

In validation step 906, the prediction module 37 undergoes validation for multiple qualities of the final product. In some embodiments, the verification of the prediction module 37 is performed using Equations 1, 2, 3, and 4:

$$Range = {x}_{max} - {x}_{min} \qquad ( 1 )$$

Range represents range of the testing set;
xₘₐₓ represents the maximum predicted value in the testing set; and
xₘᵢₙ represents the minimum predicted value in the testing set.

$$σ = \sqrt{\frac{\sum {( {x}_{i} - \overline{x} )}^{2}}{n - 1}} \qquad ( 2 )$$

σ represents the standard deviation of the predicted values;
xᵢ represents the predicted values;
x̅ represents the mean of the predicted values; and
n represents the total number.

$$Max . upper deviation = {x}_{max} - {x}_{s i m} \qquad ( 3 )$$

$$Max . lower deviation = {x}_{min} - {x}_{s i m} \qquad ( 4 )$$

Max.upper deviation represents the maximum value by which the prediction overestimates the actual simulation value;
Max.lower deviation represents the maximum deviation amount by underestimating the simulated actual value;
xₘₐₓ represents the maximum value among the test sets;
xₘᵢₙ represents the minimum value among the test sets; and
xₛᵢₘ represents the simulated value of the quality.

Turning to Table 3, which presents validation results for the width and weight predictions (including global encoding, local encoding, and index encoding) of the 11 samples (simulated data C1) shown in FIGS. 8(a) to 8(g). In Table 3, the global encoding section provides validation results for the product predictions (global prediction C2) based on the global feature dataset. The local encoding section shows validation results for product predictions (local prediction C3) using a combined dataset of injection, holding, and cooling stage features. The index encoding section shows validation results for product predictions (index prediction C4) using detected peak and integral indices. The data in Table 3 were verified using Equations 1, 2, 3, and 4.

TABLE 3

| | | Max. | Max. | | | |
|---|---|---|---|---|---|---|
| | | upper | lower | | | |
| Quality | | deviation | deviation | Range | σ | Unit |
| Global | W1 | 41.64 | −15.57 | 57.21 | 14.93 | μm |
| encoding | W2 | 50.82 | −22.13 | 72.95 | 19.31 | |
| | W3 | 38.99 | −11.34 | 50.33 | 12.92 | |
| | L1 | 109.14 | −72.60 | 181.77 | 46.62 | |
| | L2 | 98.98 | −62.08 | 161.06 | 40.65 | |
| | L3 | 108.64 | −85.87 | 194.51 | 49.81 | |
| | Weight | 149.62 | −199.56 | 349.178 | 106.35 | mg |
| Local | W1 | 6.47 | −5.05 | 11.51 | 3.10 | μm |
| encoding | W2 | 7.36 | −7.86 | 15.22 | 4.24 | |
| | W3 | 11.09 | −3.75 | 14.84 | 3.90 | |
| | L1 | 27.60 | −9.07 | 36.68 | 12.77 | |
| | L2 | 25.91 | −11.36 | 37.27 | 11.61 | |
| | L3 | 28.12 | −18.43 | 46.55 | 14.54 | |
| | Weight | 46.29 | −29.69 | 75.97 | 25.62 | mg |
| Index | W1 | 5.77 | −2.74 | 8.51 | 2.48 | μm |
| encoding | W2 | 8.48 | −2.71 | 11.19 | 3.10 | |
| | W3 | 6.81 | −0.11 | 6.92 | 2.58 | |
| | L1 | 12.44 | −4.03 | 16.47 | 5.71 | |
| | L2 | 13.60 | −6.76 | 20.36 | 6.96 | |
| | L3 | 13.37 | −3.99 | 17.36 | 5.89 | |
| | Weight | 8.98 | −44.06 | 53.04 | 14.18 | mg |

Based on the data in Table 3, it is evident that the prediction error of the global encoding values exceeds that of both the local encoding and index encoding values. The predictions obtained through index encoding and local encoding both demonstrate superior accuracy. Therefore, the local encoding method provides better predictive precision and stability for both product dimensions and weight. Accordingly, in prediction step 905, the prediction module 37, trained using the injection, holding, and cooling stage feature datasets, can be effectively applied as a monitoring technique for the production equipment 3.

Another objective of the present invention is to develop a machine learning system that can achieve high accuracy in predicting product quality without requiring domain knowledge or physically meaningful features. In some embodiments, the system is applied to injection molding technology; however, its use is not limited to this field and can be extended to other technologies as well.

From the data preprocessing step 902, the analysis of the correlation between various data encodings and product quality reveals that both the detected peak index and the detected integral index have a high correlation with product quality. The holding feature dataset and cooling feature dataset exhibit a moderate to high correlation, while the global feature dataset and injection feature dataset show almost no correlation. Therefore, in exemplary implement, it is feasible to exclude encoding of the global pressure dataset and injection pressure dataset, along with subsequent machine learning processes, to obtain accurate predictions of multiple product qualities.

Furthermore, analysis of the results from validation step 906 indicates that encoding the injection feature dataset, holding feature dataset, and cooling feature dataset separately, followed by predictions using prediction module 37, yields result superior to those obtained from directly encoding and learning from the global feature dataset. This underscores the significant improvement in the accuracy of predicting multiple product qualities through encoding and simulative learning at each stage, even in the absence of domain knowledge. Additionally, incorporating the learning and prediction results of the detected peak index and detected integral index, which are informed by domain knowledge, further enhances the ability of prediction module 37 to forecast multiple product qualities.

It is worth mentioning that the curves 501, 502, 503, and 504 in FIG. 6 represent pressure data collected by multiple detectors placed at different locations on the mold 32, each reflecting the pressure within different cavities 33. For an average observer, it is difficult to assess the product quality solely from these curves, particularly when changes in cavity pressure occur, as such variations are not easily detectable by the human eye. Therefore, the prediction module 37 disclosed in the present invention can perform the data preprocessing step 902, feature learning step 903, and model calibration step 904 to analyze the product quality based on the pressure data in curves 501, 502, 503, and 504. In practical implementation, the present invention can be applied to other production equipment 3 to accurately determine the product quality.

In summary, the present invention not only predicts multiple qualities of the finished product at each stage but also aims to achieve real-time monitoring during subsequent manufacturing operations of production equipment 3. Therefore, in exemplary implementation, the prediction module 37 does not require the use of encoded learning results from the global pressure dataset for monitoring comparisons. Instead, it relies on the encoded learning results from the injection pressure dataset, holding pressure dataset, and cooling pressure dataset for monitoring. This approach allows the prediction module 37 to analyze only relevant data without needing to utilize the entire dataset for monitoring production equipment 3. As a result, it conserves computational power, enhances the efficiency of calculations and comparisons, and significantly reduces the volume of data that needs to be processed, all while improving efficiency and contributing to energy savings and carbon reduction.

The foregoing embodiments are merely provided to describe the present disclosure, and the scope of protection of the present disclosure is not limited thereto. Equivalent substitutions or modifications made by those skilled in the art based on the present disclosure are within the scope of protection of the present disclosure.

### DESCRIPTION OF NUMERAL REFERENCES

21 Finished Product
22 Autoencoder
3 Production Equipment
31 Injection Molding Machine
32 Mold
33 Mold Cavity
34 Runner
35 Detection Module
351 Near-Gate Detector
352 Center Detector
353 Far-Gate Detector
354 System Pressure Detector
36 Computer
37 Prediction Module
411 Global Stage
412 Injection Stage
413 Holding Stage
414 Cooling Stage
501 Curve
502 Curve
503 Curve
504 Curve
901 Experimental Step
902 Data Preprocessing Step
903 Feature Learning Step
904 Model Calibration Step
905 Prediction Step
906 Validation Step
911 Process One
912 Process Two
913 Process Three
C1 Simulated Data
C2 Global Prediction
C3 Local Prediction
C4 Index Prediction
L1 Length
L2 Length
L3 Length
W1 Width
W2 Width
W3 Width

1. A method for predicting multiple qualities of finished products using feature encoding with machine learning, applicable for monitoring the manufacturing process in a production equipment, comprising:
an experimental step, wherein at least one process condition is set on the production equipment to manufacture a finished product, and a detection module is installed on the production equipment to obtain a detection data stream related to the finished product, which contains at least one quality indicator of the finished product;
a data preprocessing step, wherein an autoencoder encodes the detection data stream to obtain a feature data stream, and the detection data stream is derived from data obtained through monitoring the manufacturing process;
a feature learning step, wherein a prediction module that includes a multilayer perceptron learns from the feature data stream; and
a model calibration step, wherein the prediction module with the multilayer perceptron is used to learn and compare the quality of the finished product, and if the comparison results deviate beyond a preset threshold, the feature learning step is re-executed to allow the prediction module to simulate and refine the relationship between the feature data stream and the finished product quality, thereby enabling the prediction module to predict finished product quality and enhances the accuracy of its predictions.

2. The method for predicting multiple qualities of finished products using feature encoding with machine learning of claim 1, wherein in experimental step, the production equipment includes an injection molding machine, a mold connected to the injection molding machine, a mold cavity defined by the mold, and a runner defined by the mold, and the detection module is used to monitor the pressure in the mold cavity and the runner.

3. The method for predicting multiple qualities of finished products using feature encoding with machine learning of claim 2, wherein in data preprocessing step, the detection data stream includes an injection pressure dataset, a holding pressure dataset, and a cooling pressure dataset, and the feature data stream obtained by the autoencoder includes an injection feature dataset, a holding feature dataset, and a cooling feature dataset.

4. The method for predicting multiple qualities of finished products using feature encoding with machine learning of claim 2, wherein in data preprocessing step, the detection data stream includes a global pressure dataset, and the feature data stream obtained by the autoencoder includes a global feature dataset.

5. The method for predicting multiple qualities of finished products using feature encoding with machine learning of claim 2, wherein in experimental step, the detection module includes a near-gate detector for detecting the pressure in the mold cavity, a center detector for detecting the pressure in the mold cavity, a far-gate detector for detecting the pressure in the mold cavity, and a system pressure detector for detecting the pressure in the runner.

6. The method for predicting multiple qualities of finished products using feature encoding with machine learning of claim 1, wherein in experimental step, the quality indicators of the finished product include the finished product's dimensions and/or weight.

7. The method for predicting multiple qualities of finished products using feature encoding with machine learning of claim 1, wherein in data preprocessing step, the detection data stream includes a detected peak index and a detected integral index, and a statistical model analyzes the correlation between the finished product quality, the feature data stream, the detected peak index, and the detected integral index to adjust the autoencoder, ensuring that the feature data stream obtained by the autoencoder has a high correlation with the detected peak index and the detected integral index.

8. The method for predicting multiple qualities of finished products using feature encoding with machine learning of claim 1, further comprising a prediction step following the model calibration step, wherein in prediction step, the prediction model is incorporated into the production equipment to predict the actual production conditions of the production equipment.

9. The method for predicting multiple qualities of finished products using feature encoding with machine learning of claim 8, further comprising a validation step following the prediction step, wherein in validation step, the prediction model undergoes validation for multiple qualities of the finished product.

10. A production equipment suitable for the method of predicting multiple qualities of finished products using feature encoding with machine learning of claim 1, wherein the production equipment manufactures a finished product, comprising:
an injection molding machine;
a mold connected to the injection molding machine;
a mold cavity defined by the mold;
a runner defined by the mold;
a detection module installed in the mold for detecting the pressure in the mold cavity; and
a prediction module connected to the detection module for analyzing the detection data from the detection module and predicting the quality of the finished product.
